(19) United States
(12) Patent Application Publication
(10) Pub. No.: US 2009/0304141 A1
(43) Pub. Date: Dec. 10, 2009

(54) X-Ray CT Apparatus

(75) Inventors: Tetsuo Nakazawa, Tokyo (JP); Toru Tanimori, Kyoto (JP); Takashi Shirahata, Tokyo (JP); Osamu Miyazaki, Tokyo (JP); Koichi Hirokawa, Tokyo (JP)

Correspondence Address: COOPER & DUNHAM, LLP, 30 Rockefeller Plaza, 20th Floor, NEW YORK, NY, 10112, US

(73) Assignees: HITACHI MEDICAL CORPORATION, Tokyo (JP); KYOTO UNVERSITY, Kyoto (JP)

(21) Appl. No.: 12/298,115

(22) PCT Filed: Mar. 8, 2007
(86) PCT No.: PCT/JP2007/054520

§ 371 Date: Aug. 14, 2009

(30) Foreign Application Priority Data
Apr. 24, 2006 (JP) 2006-119398

(51) Int. Cl. H05G 1/60

(52) U.S. Cl. 378/5

(57) ABSTRACT

The photon counting type detector 122 includes a drift electrode 122a, an MSGC 122b provided at a prescribed interval and a drift region 122c formed by sealing gas between the drift electrode 122a and the MSGC 122b. The projection data outputted from the photon counting type detector 122 is discriminated by the discrimination circuit 162 for each of X-ray energies and a CT image is reconstructed based on the projection data after discrimination, thereby providing an energy discrimination type X-ray CT apparatus capable of improving image quality at lower cost.

### TECHNICAL FIELD

The present invention relates to an X-ray CT apparatus and, particularly, to an X-ray CT apparatus capable of acquiring X-ray CT images for each of energies.

### BACKGROUND ART

Conventionally, studies on an energy discrimination X-ray CT apparatus have been made. For example, there are a xenon-based X-ray CT apparatus and an X-ray CT apparatus capable of identifying X-ray energies by identifying photon energy using a semiconductor element (refer to Patent Document 1). In addition, Patent Document 2 discloses a two-dimensional thin-film gas apparatus.
Patent Document 1: Japanese Patent Application Laid-Open No. 2004-77132
Patent Document 2: Japanese Patent No. 3354551

### DISCLOSURE OF THE INVENTION

### Problem to be Solved by the Invention

Such an X-ray CT apparatus that discriminates energies by a detector using a semiconductor element as disclosed in Patent Document 1 has a problem of causing the whole apparatus to be expensive because of expensive unit price of the semiconductor element.

In the case of an image reconstructed by energy discrimination, there occurs the following problem: the image becomes blurry depending upon scanning conditions and hence, in performing an image diagnosis using the reconstructed image, efficiency may become low.

It is therefore an aim of the present invention to provide an energy discrimination type X-ray CT apparatus capable of improving image quality at lower cost.

### MEANS FOR SOLVING THE PROBLEM

To achieve the aim, an X-ray CT apparatus according to the present invention comprises: an X-ray source that irradiates continuous X rays including a plurality of X-ray energies; a first X-ray detector that detects the X rays, discriminates the X-ray energies and outputs a first projection data capable of identifying the X-ray energies; a rotation device that rotates with the X-ray source and the first X-ray detector installed thereon; an image processing device that reconstructs the first projection data and generates a first reconstructed image with the X-ray energies identified; and a display device that displays an image generated by the image processing device.

### ADVANTAGEOUS EFFECT OF THE INVENTION

According to the present invention, it becomes possible to generate a reconstructed image with energy identified using a two-dimensional detector. Particularly, when a gas detector using a pixel electrode is employed, it becomes possible to manufacture an apparatus at a lower cost than an apparatus employing a detector using a semiconductor element. Further, the characteristic of the gas detector using the pixel electrode can suppress image noise.

### BRIEF DESCRIPTION OF THE DRAWINGS

FIG. 1 is a conceptual view illustrating a configuration of an X-ray CT apparatus 1;

FIG. 2 is a block diagram illustrating a hardware configuration of an X-ray CT apparatus 1;

FIG. 3 is a block diagram illustrating flows of projection data and reconstructed images in an X-ray CT apparatus 1 according to a first embodiment;

FIGS. 4(a) and 4(b) are schematic views illustrating a pixel electrode type detector, respectively;

FIG. 5 is a schematic view illustrating X-ray photon in a pixel electrode type detector;

FIGS. 6(a), 6(b) and 6(c) are views illustrating a beam hardening effect, respectively;

FIGS. 7(a) and (b) are schematic views illustrating a method for counting the number of X-ray for each X-ray energy to perform reconstruction;

FIGS. 8(a) and 8(b) are views illustrating a difference between images by energy discrimination, respectively; and

FIG. 9 is a block diagram for illustrating flows of projection data and reconstructed images in an X-ray CT apparatus 1 according to a second embodiment.

### DESCRIPTION OF SYMBOLS

1 X-ray CT apparatus
10 Scanner rotation unit
20 Image processing unit
30 Image display unit

### BEST MODE FOR CARRYING OUT THE INVENTION

Referring now to the accompanying drawings, the best mode for carrying out the invention will be described below. In all the drawings for illustrating embodiments of the invention, components having the same function have the same reference numeral or reference character, respectively, and repeated descriptions will not be repeated.

### First Embodiment

The first embodiment is an embodiment of an X-ray CT apparatus installed with a two-dimensional optical energy discrimination detector.

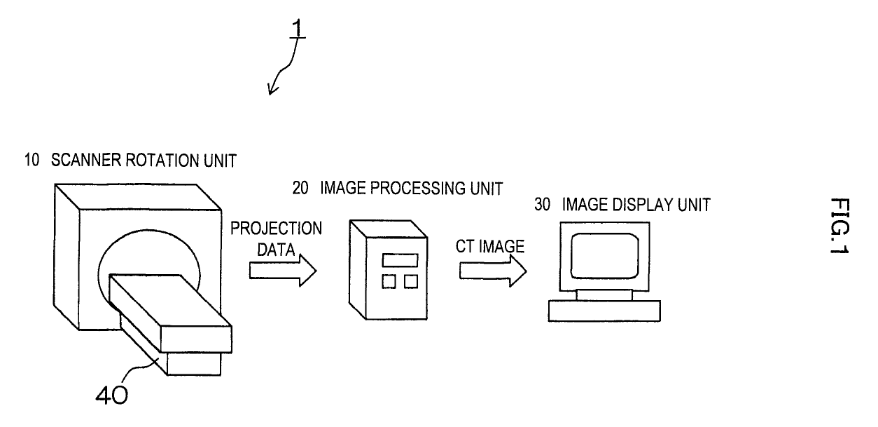

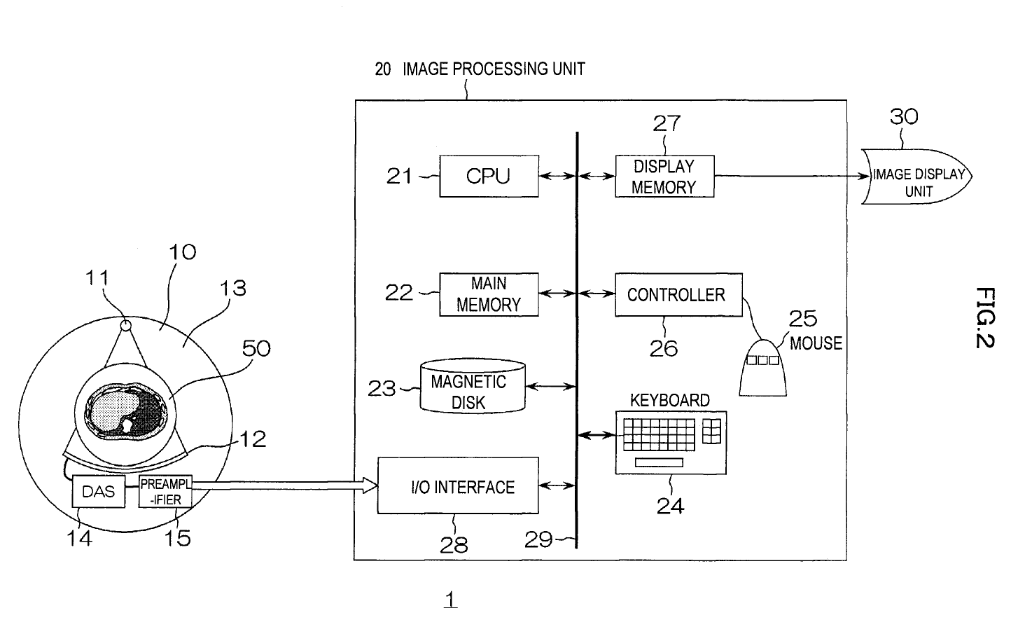

FIG. 1 is a conceptual view illustrating a configuration of an X-ray CT apparatus 1 according to one embodiment of the present invention. FIG. 2 is a block diagram illustrating a hardware configuration of an X-ray CT apparatus 1 in FIG. 1.

An X-ray CT apparatus in FIG. 1 includes a scanner rotation unit 10 for outputting a projection data, an image processing unit 20 for performing image reconstruction based on the projection data and generating a reconstructed image, and an image display unit 30 for displaying a reconstructed image.

The scanner rotation unit 10, as illustrated in FIG. 2, includes an X-ray source having an X-ray tube 11 irradiating X-ray beams being spread in a conical or pyramid shape and a detector 12 for detecting a transmission X-ray. The scanner rotation unit 10 has a rotation panel 13 for rotating the circumference of an object to be examined (object) 50 placed on a bed 40 with the X-ray source 11 and the detector 12 facing each other.

The detector 12 detects a transmitted X ray passing through an object 50 and outputs a projection data through a data acquisition system 14 (hereinafter referred to as “DAS”). The DAS 14 is connected to a preamplifier 15. The preamplifier 15 amplifies a projection data received from DAS 14 and transmits the amplified projection data to the image processing unit 20. Currently, the time required for the rotation of the rotation panel 13 installed with the X-ray tube 11 and the detector 12 per lap has become as high as 0.5 sec. or less. As the detector 12, multi-slice detection units having a structure formed from detectors arranged in a plurality of rows in a body-axis direction so as to obtain a plurality of tomographic images in one scan have become popular.

The image processing unit 20 includes: a CPU 21; a main memory 22 for storing a control program and an image processing program of the image processing unit 20; a magnetic disk 23 for storing a projection data and an image processing program; a key board 24 for setting parameters such as an effective field of view; a pointing device such as a mouse 25, a track ball or a joystick and a controller 26 therefor; a display memory 27 for temporarily storing an image data to be displayed on the image display unit 30; and an I/O interface 28 for acquiring a projection data from the scanner rotation unit 10. The above-described components are connected to each other through a common bus 29. The image processing unit 20 includes the main memory 22 and the magnetic disk 23 as a storage device, but may include another storage device, such as FDD, CD-RW drive, MO (magneto optical disk) drive or ZIP drive.

The image processing unit 20 of the X-ray CT apparatus 1 is installed with an image processing program for generating a reconstructed image by reconstructing a projection data. The CPU 21 loads the image processing program on the main memory 22 to execute the program as needed and hence a reconstruction processing unit for reconstructing the projection data outputted from the detector 12 is comprised.

The image display unit 30 is a CRT unit or a liquid crystal display unit and so on.

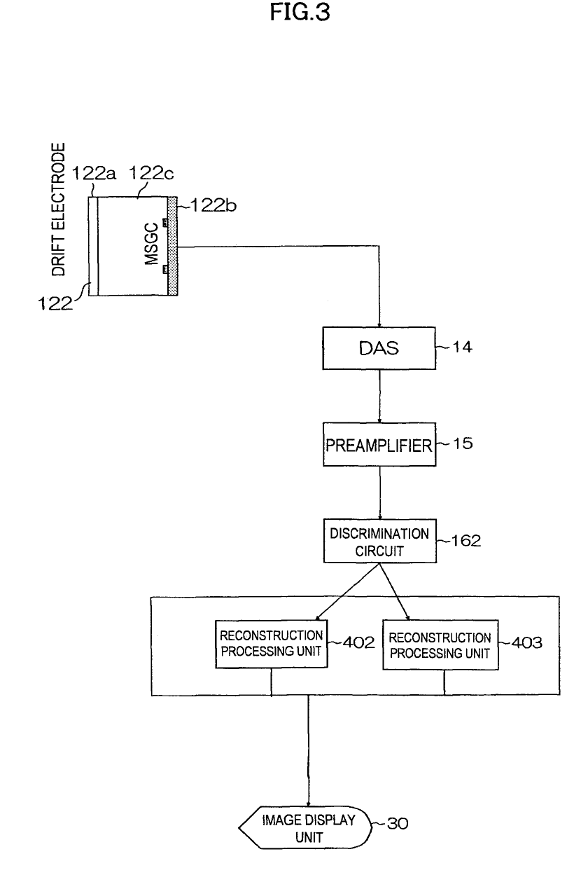

FIG. 3 is a block diagram illustrating flows of projection data and reconstructed images in an X-ray CT apparatus 1.

The detector 12 is configured as a photon counting type detector 122 that discriminates and detects continuous X rays including a plurality of X-ray energies irradiated by the X-ray source for each of the X-ray energies.

The photon counting type detector 122 is configured by a drift electrode 122a, an MSGC (Micro Strip Gas Chamber) 122b provided at a prescribed interval and a drift region 122c formed by sealing gas between the drift electrode 122a and the MSGC 122b.

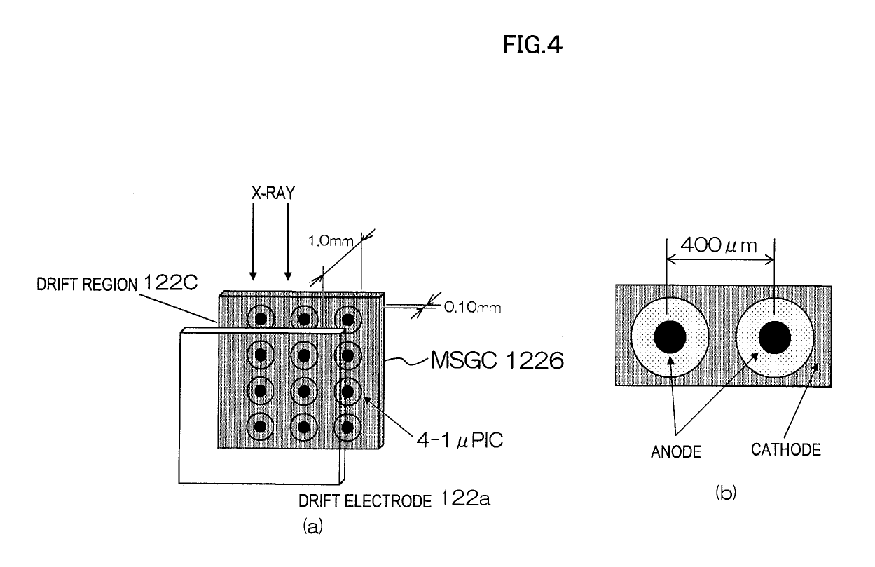

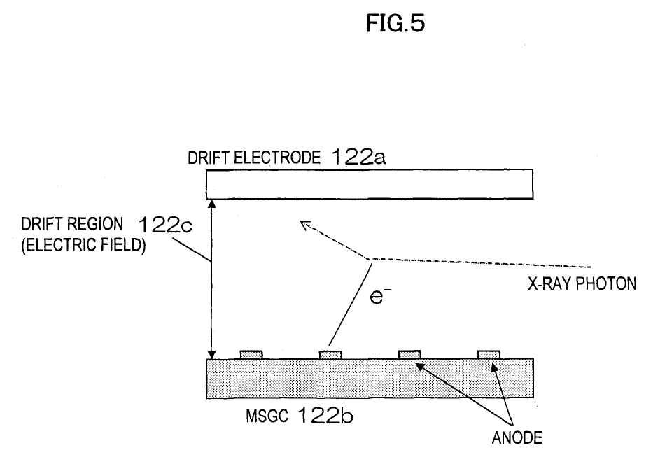

To detect X-ray photon, various technologies have been proposed for X-ray photon counting type detectors, but in the present embodiment, description will be made using a pixel electrode type detector disclosed in Patent Document 2. FIGS. 4 and 5 are a schematic view illustrating a pixel electrode type detector.

As illustrated in FIG. 4(a), the drift region 122c between the drift electrode 122a and MSGC 122b is sealed with gas therein, and further an electric field is applied thereto. The principle of the detector is as follows: The recoil electrons produced by an incident X-ray photon into the drift region 122c are drifted to be caught in the MSGC 122b. FIG. 4(b) illustrates only MSGC 122b and a relationship between anode and cathode.

FIG. 5 illustrates a state of FIG. 4(a) when viewed from the side face and a relationship between incidence of an X-ray photon and a recoil electron. FIG. 5 illustrates a state where an incident X-ray photon from the right produces an electron inside the drift region 122c and the recoil electron reaches the MSGC.

The MSGC 122b is sequentially connected to DAS 14, the preamplifier 15 and a discrimination circuit 162 for discrimination to a projection data for each of the X-ray energies. The discrimination circuit 162 is a circuit for discriminating incident X-ray energies using a comparator and is connected to each of reconstruction processing units 402, 403 for executing a reconstruction algorithm adapted to discriminated X-ray energies.

FIG. 3 illustrates that the two reconstruction processing units 402, 403 are connected to the discrimination circuit 162, but the number of the reconstruction processing units to be connected is not limited to two and may be optionally determined depending upon the number of types of projection data to be discriminated.

The discrimination circuit 162 may be disposed nearer to a photon counting type detector than DAS 14. In this case, the projection data outputted from the photon counting type detector 122 is discriminated by the discrimination circuit 162 for each of X-ray energies and the projection data discriminated for each of the X-ray energies are collected by DAS 14 and amplified by the preamplifier 15.

For the reconstruction algorithm of the image processing program, a single energy is assumed. Therefore, an X-ray CT apparatus using continuous X rays generates an artifact by a beam hardening effect. Generally, when continuous X rays pass through a subject, lower energy (soft) X rays are more absorbed and energy distribution shifts to a high side. This is the reason why X rays harden.

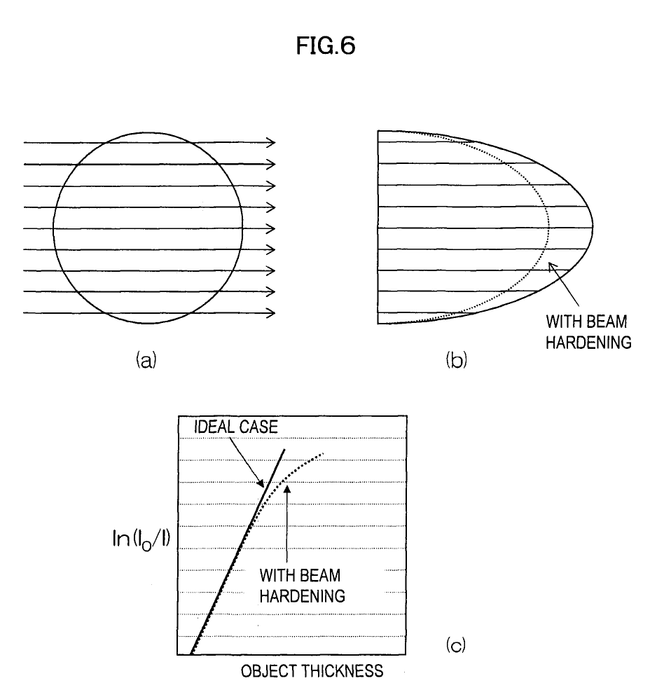

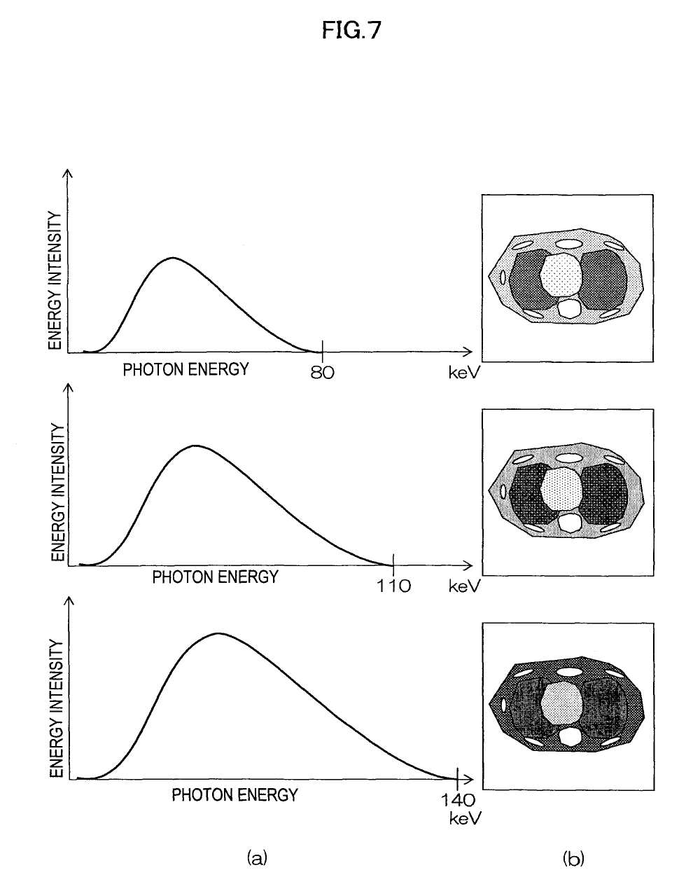

Referring to FIG. 7, the beam hardening effect will be described below. FIG. 6 illustrates a case where an ideal cylinder (FIG. 6(a)) made of a substance of uniform density is CT-scanned with single energy X rays as an example. The projection data obtained in this case is directly proportional to the thickness of a substance along the direction of X-ray beams. However, where continuous X rays are used, as the thickness of a substance is larger, low energy side is more absorbed, which makes it difficult for X rays to go through the substance. As illustrated in FIG. 6(b), the projection data becomes smaller than in the case of single energy. A relationship between In(Io/I) (logarithm ratio of incident X ray to transmission X ray) and thickness of a subject is as illustrated in FIG. 6(c). Ideally, a straight line indicated by a solid line should be made, but actually a line curving on the lower side than the straight line is drawn, as indicated by a dotted line because X ray hardens.

As a method for correcting a beam hardening effect, there are two methods: one method employs a hardware using a compensation filter having an effect to make X rays weaker in the peripheral portion than in the central portion of a human body according to a human body's shape, and the other method is dependent upon software for mathematically correcting non-linearity illustrated by a dotted line of FIG. 6(c). Both methods do not resolve the artifact in principle, are techniques for suppressing the artifact by the beam hardening effect.

As means for eliminating an artifact by the beam hardening effect, there is suggested a method for reconstruction by counting X-ray photon for each of X-ray energies.

Now, description will be made on reconstruction by counting X-ray photon for each of X-ray energies.

FIG. 7 is a schematic view illustrating a method for counting the number of X-ray for each X-ray energy to perform reconstruction. FIG. 7(a) illustrates a relationship between photon energy and energy intensity in performing X-ray energy discrimination and FIG. 7(b) illustrates an image reconstructed according to photon energy and energy intensity.

Energy discrimination provides an image having clear contrast (CT value difference), for example, between the bone and contrast-enhanced tissue.

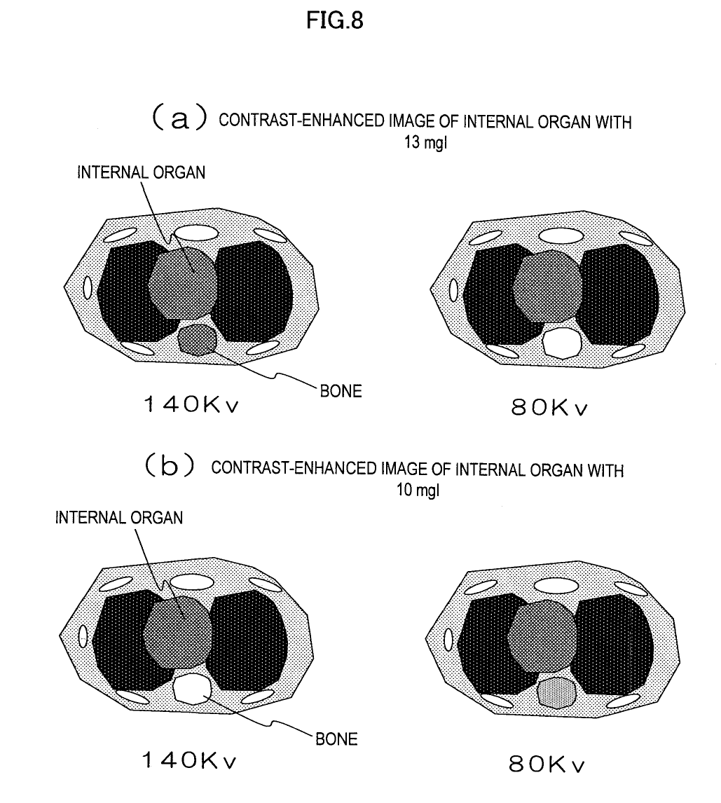

First, description will be made on a case where an internal organ, such as a heart, is contrast-enhanced with 13 mgl. When reconstruction processing is performed with scan at 140 kV as illustrated in FIG. 8(a), little CT value difference occurs between bone and contrast-enhanced internal organ and therefore contrast becomes small and identification of the bone from the contrast-enhanced internal organ is difficult. However, when a projection data scanned at 140 kV is discriminated and reconstructed to obtain a projection data of about 80 kV or less, a CT value difference of approximately 100 occurs between the bone and the contrast-enhanced internal organ and therefore the contrast becomes large, thus facilitating identification between the bone and the contrast-enhanced internal organ.

The contrast-enhancement concentration (dyeing state) of the internal organ sometimes not only changes momentarily (changes with time) but also causes a difference by an object (individual difference). The internal organ contrast-enhanced with 10 mgl has a different tendency from the internal organ contrast-enhanced with 13 mgl. When projection data scanned at 140 kV is discriminated and reconstructed to obtain a projection data of about 80 kV or less as illustrated in FIG. 8(b), little CT value difference occurs between the bone and the contrast-enhanced internal organ. However, when reconstruction processing is performed with scan at 140 kV, a CT value difference of approximately 50 occurs between the bone and contrast-enhanced internal organ.

Specifically, scan is made at a high tube voltage and an image is generated within an optional energy range as needed, thus providing a targeted reconstructed image with high efficiency.

By acquiring a reconstructed image for each energy, an image of only the contrast-enhanced internal organ can be generated easily. Conversely, a bone region can be easily deleted on the reconstructed image. High concentration of contrast agent provides high contrast in an ordinary reconstruction, but low concentration of the contrast agent has a merit of low physical burden on an object.

The number of X-ray photons of X rays which have passed through the object or a material is counted and reconstructed images are acquired for each energy, thus neglecting the beam hardening effect. By synthesizing the images reconstructed for each energy, images can be generated without generation of artifacts. In addition, a plurality of reconstructed images are prepared for each energy and the difference image is generated, thus achieving images useful in identifying an abnormal site.

According to the present embodiment, measurement of individual X-ray quantum can completely eliminate an influence of electric noise and improving image quality up to image quality of theoretical limit being statistically determined. In addition, the image quality of a focus having high absorbance can be markedly improved.

An X-ray color CT by X-ray quantum energy discrimination may promise epoch-making advance of a CT apparatus such as high image quality by elimination of in-body scattered X rays, identification of a focus by a difference of different energy images and improvement of sensitivity of the contrast agent, thus providing fundamental technology for a next-generation X-ray CT apparatus. Further, MSGC is highly excellent in counting rate and has performance high enough to bear high-intensity X rays required for a CT apparatus for human body.

According to the present invention, by replacing a charge collection plate electrode of X-ray CT apparatus being currently used with the MSGC, even minor modification from a conventional X-ray CT technology allows improvement of the image quality of a conventional xenon-based X-ray CT apparatus, acquirement of quantum images for measurement of the number of X-ray quantums and suppression of image noise to quantum noise limit as well as realization of X-ray color CT apparatus by energy discrimination.

### Second Embodiment

A second embodiment is an X-ray CT apparatus is configured by layering an energy discrimination detector (first X-ray detector) and an energy non-discrimination detector (second X-ray detector). The X-ray CT apparatus according to the second embodiment has the same configuration as that according to the first embodiment, except the following: the two types of X-ray detectors layered; a processing flow of projection data outputted from the respective X-ray detectors; and images displayed using the projection data.

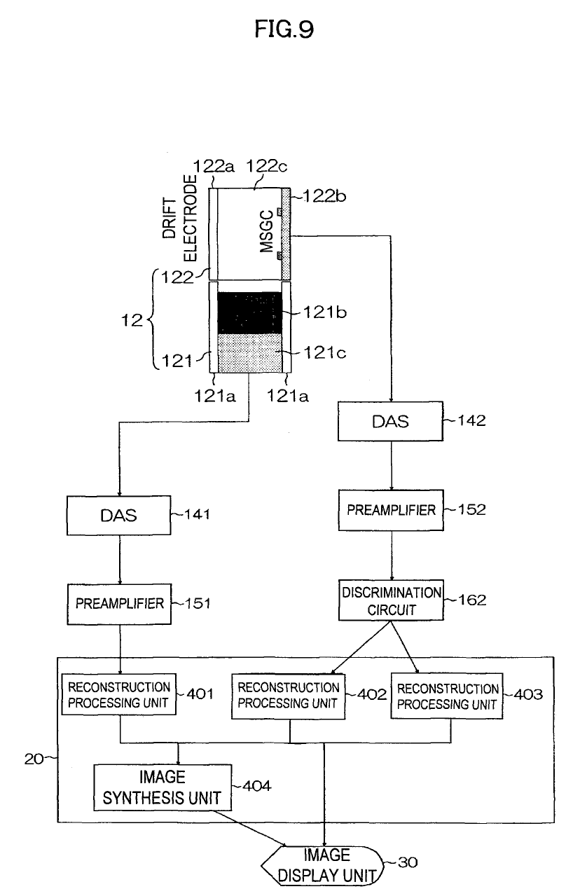

FIG. 9 is a block diagram for illustrating flows of projection data and reconstructed images in an X-ray CT apparatus according to a second embodiment.

The detector 12 includes a second detector which detects continuous X rays including a plurality of X-ray energies irradiated by an X-ray source with the X-ray energies mixed without discrimination for each X-ray energy and a first X-ray detector which discriminates and detects the continuous X rays for each X-ray energy. The present embodiment uses a photon counting type detector as the first X-ray detector, and a photon non-counting type detector as the second X-ray detector, respectively. A plurality of DASs 14 and preamplifiers 15 are provided for each of the first X-ray detector and the second X-ray detector, respectively.

The detector 12 is configured by layering a photon counting type detector 122 on a photon non-counting type detector 121. As the photon non-counting type detector 121, an ionization chamber detector using X-ray ionization or a solid detector using fluorescence characteristic by X rays can be used. In the present embodiment, the solid detector is used.

The solid detector 121 includes a separator 121a, a scintillator 121b and a photodiode 121c. The separator 121a is disposed between respective channels to remove scattered X rays. The scintillator 121b, when X rays enter, emits the light called scintillator light and the photodiode 121c detects the scintillator light and converts the light into an electric signal. This electric signal is converted-into a digital value by DAS 141 to detect the intensity of incident X rays. The projection data outputted from DAS 141 is amplified by the preamplifier 151 and inputted into a reconstruction processing unit 401 in the image processing unit 20.

The photon counting type detector 122 includes a drift electrode 122a, MSGC 122b provided at a predetermined distance and a drift region 122c formed by charging gas into between the drift electrodes 122a and MSGC 122b.

MSGC 122b is sequentially connected to DAS 142, a preamplifier 152 and a discrimination circuit 162 for discriminating projection data for each X-ray energy. The discrimination circuit 162 is plural-connected to reconstruction processing units 402, 403 for executing a reconstruction algorithm corresponding to X-ray energy to be discriminated. In FIG. 9, two reconstruction processing units 402, 403 are connected to the discrimination circuit 162. The number of the reconstruction processing units is not limited to two and the reconstruction processing units may be provided corresponding to the number of projection data to be discriminated.

The discrimination circuit 162 may be provided nearer to the photon counting type detector 122 than DAS 142. In this case, the projection data outputted from the photon counting type detector 122 is discriminated by the discrimination circuit 162 for each X-ray energy, and the discriminated projection data for each X-ray energy is collected by DAS 142 and amplified by the preamplifier 152.

Each configured image generated by the reconstruction processing units 401, 402, and 403 may be singly displayed on the image display unit 30. Optional combinations of respective reconstructed images generated by the reconstruction processing units 401, 402, and 403 may be synthesized by the image processing unit 404 to display the synthesized reconstructed images on the image display unit 30.

The energy-discriminated reconstructed images generated by the reconstruction processing units 402, 403 may be blurry depending upon scanning conditions. Accordingly, in performing image diagnosis using only a reconstructed image generated by the reconstruction processing units 402, 403, working efficiency may be lowered. In such a case, by synthesizing energy-discriminated reconstructed images generated by the reconstruction processing units 402, 403 and a reconstructed image generated by the reconstruction processing unit 401, images which facilitate identification of internal organs can be obtained while utilizing an advantage of energy-discriminated reconstructed images being useful for identification of an abnormal site.

According to the present invention, as illustrated in FIG. 8, the photon counting type detector 122 using MSGC is installed on the upper portion of the solid detector 121. Hence, the X-ray photon which has passed through a human body is detected by the photon by the former stage of photo counting type detector and, based on the data, reconstruction of images is implemented by the reconstruction processing units 402, 403 for each X-ray energy.

The X-ray photon not detected by the former stage of photon counting type detector 122 is measured by the latter stage of solid detector 121 and is utilized to achieve an ordinary reconstructed image.

If the former stage of photon counting type detector 122 detects most of X-ray photon which has passed through a human body, there becomes a small amount of X rays which the latter stage of solid detectors 121 detects, thus making it difficult to achieve reconstructed images effective in clinical services. To solve such a problem, it is sufficient that the former stage of photon detector detects photon only to such an extent that images can be reconstructed for each X-ray energy. Conversely, this can be implemented by adopting a configuration which controls photon detection capability per unit time of MSCT and detects most of transmission X ray with the solid detector 121.

Improvement of MSGC performance, such as detection efficiency of recoil electrons, can be implemented by changing the pressure of gas sealed into a draft region 122c.

The above-described embodiment describes a multi-stage configuration of the solid detector 121 and the photon counting type detector. The drift electrode substrate and MSGC of the photon counting type detector 122 may be used as a separator of the solid detector 121 and therefore mounting of the separator of the solid detector 121 can be eliminated.

The above embodiment describes the configuration having the solid detector 121 and the photon counting type detector 122 using MSGC, but even another combination of an X-ray photon non-counting type detector and an X-ray photon counting type detector will provide the same advantages of the present invention.

For example, a combination of an ionization chamber detector and a semiconductor detector, such as CdTe (cadmium telluride), will exhibit the same advantages of the present invention.

Adoption of an X-ray CT apparatus mounted with a multi-stage detector having an X-ray detector using MSGC as an X-ray photon counting type detector and an X-ray photon non-counting type detector will achieve both of an energy-decomposed CT image and an ordinary CT image, thus providing clinically-effective information to health workers.

1. An X-ray CT apparatus comprising:
an X-ray source that irradiates continuous X rays including a plurality of X-ray energies;
a first X-ray detector that detects the X rays, discriminates the X-ray energies and outputs a first projection data capable of identifying the X-ray energies;
a rotation device that rotates with the X-ray source and the first X-ray detector installed thereon;
an image processing device that reconstructs the first projection data and generates a first reconstructed image with the X-ray energies identified; and
a display device that displays an image generated by the image processing device.

2. The X-ray CT apparatus according to claim 1, comprising
a first reconstructed image synthesis device that synthesizes the first reconstructed image for each X-ray energy generated by the image processing device, wherein
the display device displays an image generated by the image processing device and/or an image synthesized by the first reconstructed image synthesis device.

3. The X-ray CT apparatus according to claim 1, comprising
a difference image construction device that constructs a difference image of the first reconstructed image generated by the image processing device for each of the plurality of X-ray energies, wherein
the display device displays an image generated by the image processing device and/or a difference image constructed by the difference image construction device.

4. The X-ray CT apparatus according to claim 1, further comprising
a second X-ray detector that detects an X ray not detected by the first X-ray detector and outputs a second projection data based on the X ray not detected by the first X-ray detector, wherein
the rotation device rotates with the X-ray source, the first X-ray detector and the second X-ray detector installed;
the image processing device reconstructs a second reconstructed image based on the second projection data; and
the display device displays at least one of the first reconstructed image and the second reconstructed image.

5. The X-ray CT apparatus according to claim 4, further comprising
a synthesis device that generates a synthesized image by synthesizing the first reconstructed image and the second reconstructed image, wherein
the display device further displays the synthesized image.

6. The X-ray CT apparatus according to claim 4, wherein
the first X-ray detector is an X-ray photon counting type detector;
the second X-ray detector is an X-ray photon non-counting type detector;
the X-ray photon non-counting type detector is layered under the detector X-ray photon counting type along an incidence direction of the continuous X rays.

7. The X-ray CT apparatus according to claim 1, wherein
the first X-ray detector is an X-ray detector using gas amplification by a pixel type electrode, comprising:
(a) an anode strip formed on a back face of a double-faced substrate;
(b) a cylindrical anode electrode which is planted in the anode strip and whose upper end face is exposed on a surface of the double-faced substrate; and
(c) a strip cathode electrode on which holes are formed around an upper end face of the cylindrical anode electrode.

8. The X-ray CT apparatus according to claim 6, wherein
the second X-ray detector is a solid detector and a drift electrode substrate of the first X-ray detector and MSGC are shared with a separator of the solid detector.

9. The X-ray CT apparatus according to claim 7, wherein
the second X-ray detector detects the continuous X rays passing through a drift region of the first X-ray detector.
